(19) United States
(12) Patent Application Publication
(10) Pub. No.: US 2006/0059546 A1
(43) Pub. Date: Mar. 16, 2006

(54) Single sign-on identity and access management and user authentication method and apparatus

(76) Inventors: David Nester, Houston, TX (US); Jeffrey Scott Cyr, Davison, MI (US); David Wayne Markle, Landenburg, PA (US)

Correspondence Address: YOUNG & BASILE, P.C., 3001 WEST BIG BEAVER ROAD, SUITE 624, TROY, MI, 48084, US

(21) Appl. No.: 11/218,115

(22) Filed: Sep. 1, 2005

Related U.S. Application Data
(60) Provisional application No. 60/606,445, filed on Sep. 1, 2004.

(51) Int. Cl. H04L 9/32

(52) U.S. Cl. 726/5

(57) ABSTRACT

A single sign-on authentication and access management apparatus and method is provided for computer networked digital content providers interconnected in a communication network. A single application service provider coupled to the application servers and a user computer includes an entitlements database interfaced with an authorization server for storing data utilized by the authorization server to responding to user requests to grant or deny access to user requested content.

### CROSS-REFERENCE TO CO-PENDING APPLICATION

This application claims the priority benefit of the benefit of co-pending U.S. Provisional Application Ser. No. 60/606,445, filed Sep. 1, 2004, the contents of which are incorporated herein in its entirety.

### BACKGROUND

Computer networks allow access to a wide range of content from multiple users. Both Web enabled and non-Web enabled applications can be accessed by multiple users through a computer network.

However, there are major concerns regarding control of access to critical applications and content and to approve access requests for certain authorized individuals while rejecting access request by non-authenticated, non-authorized users.

In today's digital environment, a plurality of different network content providers, such as different companies or groups within a single company, are linked in a federated network. This allows a user to access the content of each provider through a single sign on.

Various authentication protocols have been implemented to control access, provide each user with different access rights to different network content, as well as providing intrusion detection, firewalls, etc.

One approach, provides a cookie or token upon authentication of each user to a federated network. The cookie defines the user's unique access rights to various network content. Software is utilized at each network provider to accept cookies or tokens to allow controlled access to the network.

Each user, upon first accessing the network, is required to execute an authentication process. Once authenticated, the user information is embodied in the cookie or token thereby enabling a simple sign-on upon the next network access without requiring complete user information, such as password, etc.

Thus, in this authentication method, each network provider communicates with all of the other network providers to control user access. The main authentication software is accessed only upon the first network access by a user.

Thus, it would be desirable to provide a single sign-on authentication apparatus and method for computer networked digital content providers.

### SUMMARY

A sign-on identity, access and authentication apparatus comprising:

at least one computer operated by a user;

a plurality of application servers for executing applications in response to access granted to a request generated by the user;

a communication link for interconnecting the computer operated by the user and one application server;

a single application service provider coupled to each of the application servers and to the user computer by the communication link for performing authorization processing; and

the application service provider including an entitlements database interfaced with an authorization server for storing data utilized by the authorization server for responding to user requests to one of granting or denying access to the requested application to the user.

A method of controlling access and security for a plurality of discrete application servers coupled by a computer network comprises the steps of:

providing an application service provider coupled via the computer network with the plurality of application servers and at least one user;

providing an authorization server in the application service provider interfaced with an entitlements database for storing data utilized by the authorization server for responding to a request generated by the user to one of granting or denying a request for execution of an application by the user; and

providing by the application service provider single sign on authentication of a user upon each request for access to an application in one of the application servers.

### BRIEF DESCRIPTION OF THE DRAWING

The various features, advantages, and other uses of the present invention will become more apparent by referring to the following detailed description and drawing in which:

FIG. 1 is a block diagram showing the inventive identity and access management apparatus with federated identity management and authentication modules and a single customer;

FIG. 2 is a block diagram, similar to FIG. 1, but showing the use of the inventive identity and access management apparatus with multiple customers;

FIG. 3 is a block diagram, similar to FIG. 1, but showing the inventive identity and access management apparatus with multiple customers which have different access agents;

FIG. 4 is a block diagram of the inventive identity and access management apparatus shown with multiple customers having one or more proprietary or open source access agents;

FIG. 5 is a block diagram showing the authentication process for a single customer having an access control agent; and

FIG. 6 is a block diagram showing the use and process for the inventive identity and access management apparatus with multiple sources.

### DETAILED DESCRIPTION

The following description of the inventive identity and access management apparatus and method will be described in conjunction with a security and access management system disclosed in U.S. Pat. No. 6,460,141, also known as ClearTrust®. It will be understood that the present apparatus and method is also useable with other authentication and access management systems.

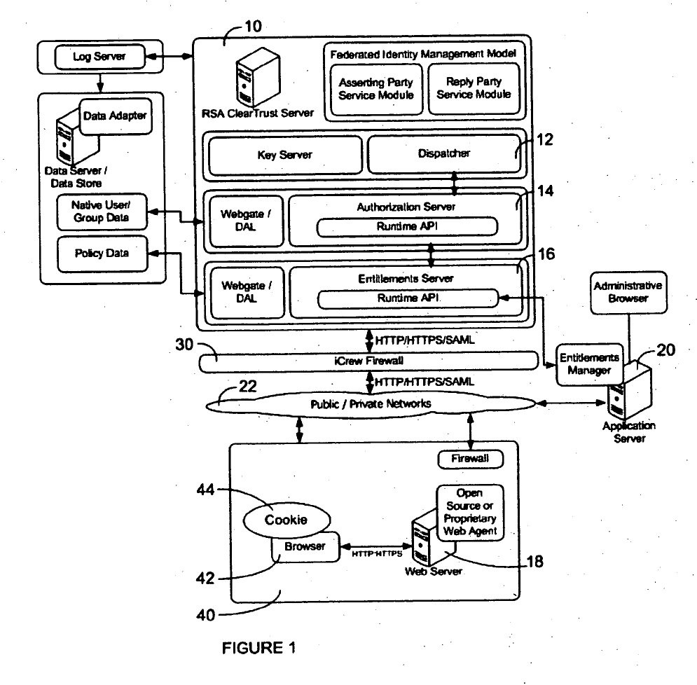

As explained more fully in U.S. Pat. No. 6,460,141, the contents of which are incorporated herein in its entirety, the security and access management module 10 includes five main components: at least one authorization component formed of a server dispatcher 12 and an authorization server 14, an entitlements database server component 16 which communicates with an application server 20. The application server 20 shown in FIGS. 1-6 is about one of a plurality of distinct application servers which are interconnected by a public or private network 22.

The identity and access module 10 is hosted at an application service provider (ASP) site protected by a security firewall 30. The application service provider (ASP) site is coupled between each application server 20, the network 22, which can be a Web enabled or non-Web enabled network, and access management and one or more customers or users 40.

Instead of accessing security software at each application server 20 site, each user or customer communicates only with the ASP site.

By way of example only, the identity and access management module 10 is a ClearTrust® module which can communicate by a proprietary or open source software by HTTP, HTTPS, SAML, or other applicable protocol.

The ASP application utilizing the module 10 enables each user to be authenticated by a single sign-on process. After the initial access and resulting authentication, a cookie or token is placed in the user's browser which will enable the user to subsequently access the protected resources on the application servers 20 via the network 22 with only minimal sign-on requirements, such as a password.

The various FIGS. 1-5 show different user configurations with a single ASP using the access management module 10 for access to protected resources on one or more application servers 20.

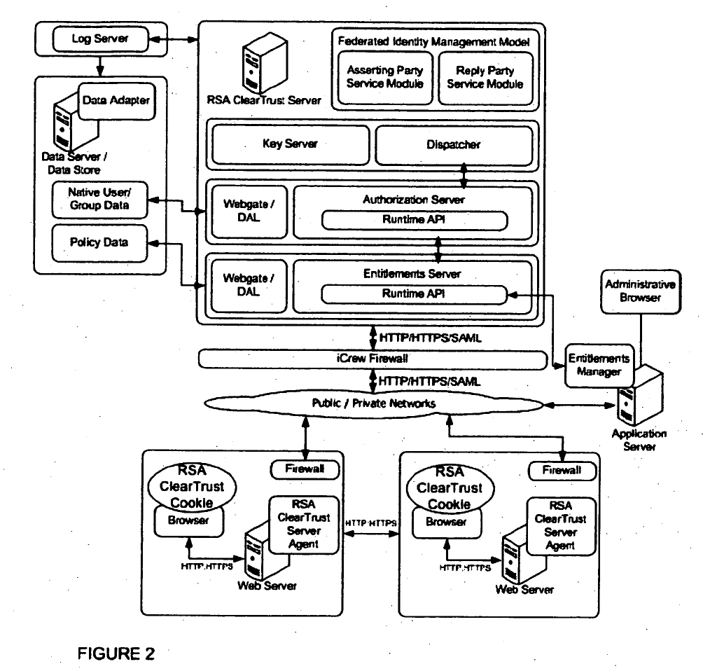

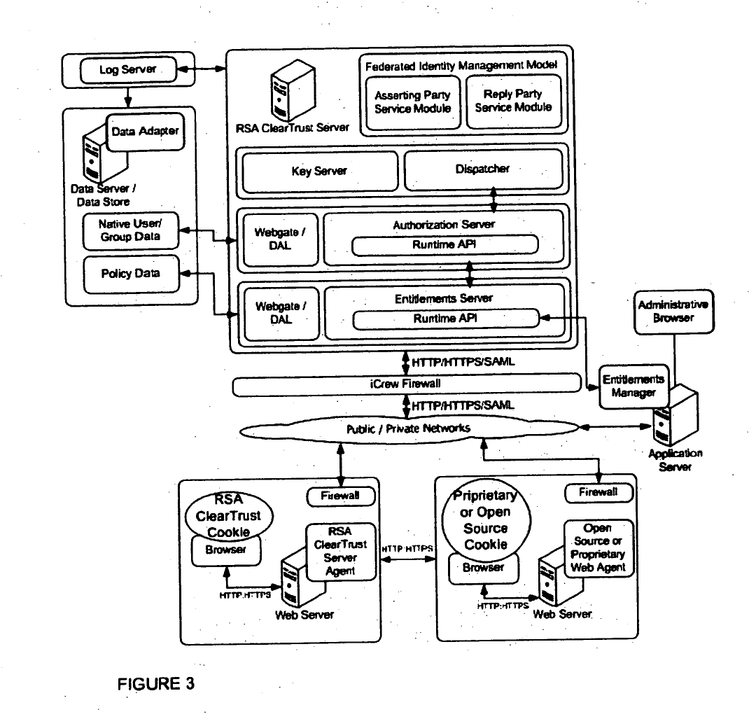

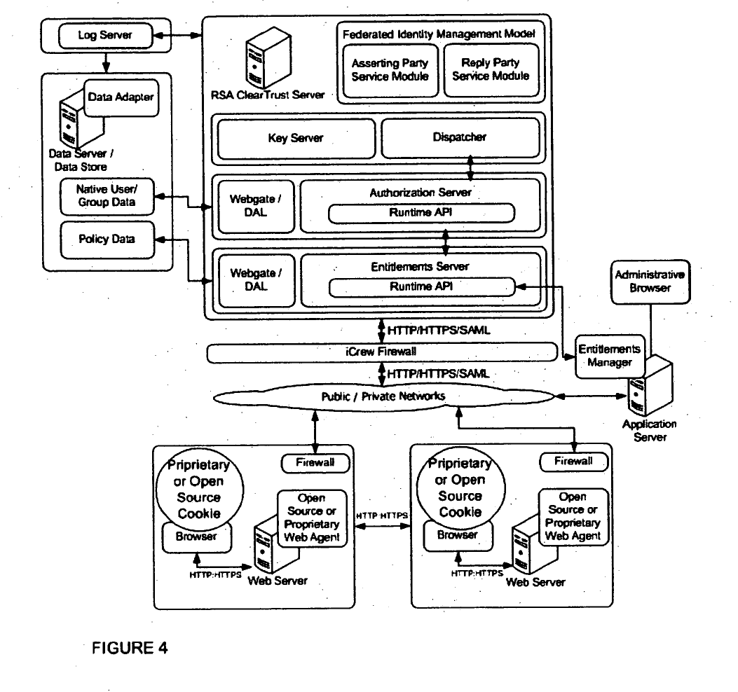

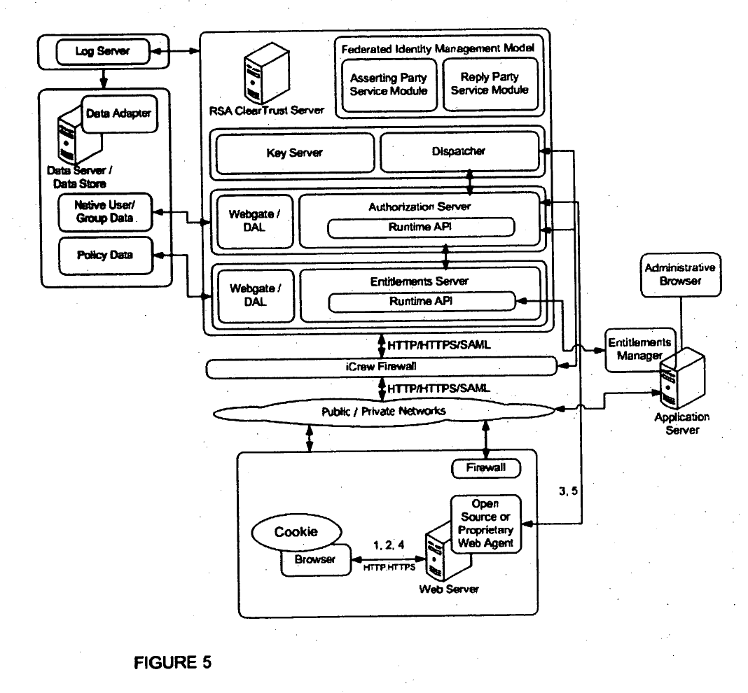

In FIG. 1, the inventive apparatus and method is used with a federated identity management and authentication modules, as well as a single customer. In FIG. 2, the same identity and access management apparatus and method is disclosed, but with multiple customers. In FIG. 3, the inventive apparatus and method is depicted in use with multiple customers each having different access agents. In FIG. 4, the inventive apparatus and method is shown with multiple customers having one or more proprietary or open source access agents. In FIG. 5, the inventive identity and access management apparatus is shown with a single customer having an access control agent.

An example of the process for authentication of a user to a protected resource on one or more application servers 20 includes the following steps:

1. a user 40 attempts to access a protected resource via a web browser 42 through the network 22.

2. The identity and access management module 10 at the host ASP site will search the user's browser for a cookie or token 44.

3. If no authorized cookie or token 44 is found, the ASP agent will perform a remote request to the authorization server 14 to verify the requested resource is a protected or non-protected resource.

4. If the resource is defined as a protected resource, the ASP agent will prompt the user for defined authentication credentials.

5. The ASP agent will forward the user input to the authorization server 14 for validation.

6. If the authentication server 14 validates the user as true, the authorization server 14 will build the cookie or token 44 and submit the cookie 44 to the user's browser 42 whereby the user will granted access to the protected resource on the application server(s) 20. This cookie or token 44 will be transmitted by HTTP/ HHTPS, SAML, or other applicable protocol from the ASP site to the user's browser 42 and will reside at the user or customer site.

It should be noted that the cookie or token 44 is created after the first successful authentication of a particular user. Subsequently, the cookie 44 passes a Web-user's credentials to the Web server 18 agent which eliminates the need for the user to resubmit a password. This cookie 44 enables all subsequent protected Web-servers to share authentication information. The user that authenticates with a Web-server protected by this access module 10 will not have to reenter a password when accessing the Web-server protected by the present identity and access control module 10.

The following description of the inventive identity and access management apparatus and method will be described in conjunction with a security and access management system disclosed in U.S. patent application Publication No. 20020112155. It will be understood that the present apparatus and method is also useable with other authentication and access management systems.

In U.S. patent application Publication No. 20020112155, the contents of which are incorporated herein in its entirety, the security and access management module 11 (FIG. 7) includes six main components: at least one authorization component formed of an access and authorization server 34, web gate 38 administration server 24, directory server 36, resources (46, 47), and web servers 18.

The identity and access module 11 is hosted at an application service provider (ASP) site protected by a security firewall 30. The application service provider (ASP) site is coupled between each application server 20/47, the network 22, which can be a Web enabled or non-Web enabled network, and access management and one or more customers or users 40.

Instead of accessing security software at each application server 20/47 site, each user or customer communicates only with the ASP site.

The ASP application utilizing the module 11 enables each user to be authenticated by a single sign-on process. After the initial access and resulting authentication, a cookie or token is placed in the user's browser which will enable the user to subsequently access the protected resources on the application servers 20/47 via the network 22 with only minimal sign-on requirements, such as a password.

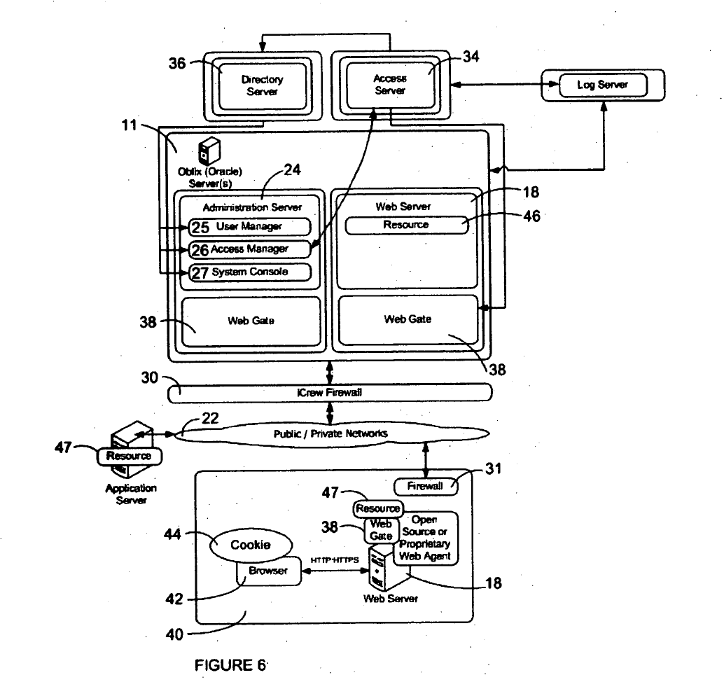

The various FIG. 6 show a modified approach towards integrating with and using different vendor products with configurations in a single ASP using the access management module 11 for access to protected resources on one or more application servers 20/47.

An example of the process for authentication of a user to a protected resource on one or more application servers 20/47 includes the following steps:

1. a user 40 attempts to access a protected resource via a web browser 42 through the network 22.

2. The identity and access management module 11 at the host ASP site will search the user's browser for a cookie or token 44.

3. If no authorized cookie or token 44 is found, the ASP agent will perform a remote request to the authorization server 20/47 to verify the requested resource is a protected or non-protected resource.

4. If the resource is defined as a protected resource, the ASP agent will prompt the user for defined authentication credentials.

5. The ASP agent will forward the user input to the authorization and access server 34 for validation.

6. If the authentication server 34 validates the user as true, the authorization server 34 will build the cookie or token 44 and submit the cookie 44 to the user's browser 42 whereby the user will granted access to the protected resource on the application server(s) 20/47. This cookie or token 44 will be transmitted by HTTP/ HHTPS or SAML from the ASP site to the user's browser 42 and will reside at the user or customer site.

It should be noted that the cookie or token 44 is created after the first successful authentication of a particular user. Subsequently, the cookie 44 passes a Web-user's credentials to the 18 agent which eliminates the need for the user to resubmit a password. This cookie 44 enables all subsequent protected Web-servers to share authentication information. The user that authenticates with a Web-server protected by this access module 10 will not have to reenter a password when accessing the Web-server protected by the present identity and access control module 11.

FIG. 6 depicts an Access System which provides identity management and access management for a network. In general, an Access System manages access to resources available to a network. The identity management portion of the Access System (hereinafter “the Identity Management System”) manages end user identity profiles, while the access management portion of the Access System (hereinafter “the Access Management System”) provides security for resources across one or more web servers. Underlying these modules is active automation, a delegation and work flow technology. The active automation technology couples the Identity and Access Management Systems by facilitating delegation of roles and rights, plus providing workflow-enabled management of end user identity profiles. One feature of one aspect of this system is the centralization of the repositories for policies and user identity profiles while decentralizing their administration. That is, one aspect of the system centralizes the policy and identity repositories by building them on a directory service technology. The system decentralizes their administration by hierarchy delegated Administrative roles. Although the Access System of FIG. 7 includes an Identity Management System and an Access Management System, other Access Systems may only include an Identity Management System or only include an Access Management System.

FIG. 6 is a block diagram depicting one aspect for deploying an Access System. FIG. 6 shows web browsers 42 accessing Web Server 18 and/or Administration Server 26 via Internet or Private Network 22. In one aspect, web browsers 42 are standard web browsers known in the art running on any suitable type of computer. FIG. 6 depicts web browsers 42 communicating with Web Server 18 and Administration Server 26 using HTTP/HTTPS over the Internet or Private Network 22; however, other protocols and networks can also be used.

Web Server 18 provides an end user with access to various resources via Internet or Private Network 22. In one aspect, there is a first firewall 30, 31 connected between Internet or Private Network 22 and Web Server 18. A second firewall (not shown) may be connected between Web Server 18 and Access Server 34.

FIG. 6shows two types of resources: resource 46 and resource 47. Resource 47 is external to Web Server 18 but can be accessed through Web Server 18. Resource 46 is located on Web Server 18. A resource can be anything that is possible to address with a uniform resource locator (URL).

FIG. 6 shows Web Server 18 including Web Gate 38, which is a software module. In one aspect, Web Gate 38 is a plug-in to Web Server 18. Web Gate 38 communicates with Access Server 34. Access Server 34 communicates with Directory Server 36.

Administration Server 24 is a web-enabled server. In one aspect, Administration Server 24 includes Web Gate 38. Other aspects of Administration Server 24 do not include Web Gate 38. Administration Server 24 also includes other software modules, including User Manager 25, Access Manager 26, and System Console 27. Directory Server 36 is in communication with User Manager 25, Access Manager 26, System Console 27, and Access Server 34. Access Manager 40 is also in communication with Access Server 34.

The system of FIG. 6 is scalable in that there can be many Web Servers (with Web Gates), many Access Servers, and multiple Administration Servers. In one aspect, Directory Server 36 is an LDAP Directory Server and communicates with other servers/modules using LDAP over SSL. In other aspects, Directory Server 36 can implement other protocols or can be other types of data repositories.

The Access Management System includes Access Server 34, Web Gate 38, (if enabled), and Access Manager 26. Access Server 34 provides authentication, authorization, and auditing (logging) services central to the ASP network Infrastructure for its customers. It further provides for identity profiles to be used across multiple domains and Web Servers from a single web-based authentication (sign-on) and placement of encrypted cookie 44. Web Gate 38 acts as an interface between Web Server 18 and Access Server 34. Web Gate 38 intercepts requests from users for resources 46 and 47, and authorizes them via Access Server 34. Access Server 34 is able to provide centralized authentication, authorization, and auditing services for resources hosted on or available to Web Server 18 and other Web Servers.

The access system enables a single sign-on authentication for each discrete user to protected resources on a network. The present apparatus and method hosts an authentication and access control module which authenticates each user's request to access protected resources on the network and supplies each user's browser, once the user is authenticated as having privileges to access protected resources on the network, with a cookie or token containing data, such as session information, encryption, time of request, random information, etc.

In this manner, the access control and security module is hosted at a single site instead of being resident in each application server. This simplifies communication and enables the above described single sign-on authentication for each user.

1. A sign-on identity, access and authentication apparatus comprising:
at least one computer operated by a user;
a plurality of application servers for executing applications in response to access granted to a request generated by the user;
a communication link for interconnecting the computer operated by the user and one application server;
a single application service provider coupled to each of the application servers and to the user computer by the communication link for performing authorization processing; and
the application service provider including an entitlements database interfaced with an authorization server for storing data utilized by the authorization server for responding to user requests to one of granting or denying access to the requested application to the user.

2. A method of controlling access and security for a plurality of discrete application servers coupled by a computer network comprises the steps of:
providing an application service provider coupled via the computer network with the plurality of application servers and at least one user;
providing an authorization server in the application service provider interfaced with an entitlements database for storing data utilized by the authorization server for responding to a request generated by the user to one of granting or denying a request for execution of an application by the user; and
providing by the application service provider single sign on authentication of a user upon each request for access to an application in one of the application servers.
